(19) United States
(12) Patent Application Publication
(10) Pub. No.: US 2014/0358808 A1
(43) Pub. Date: Dec. 4, 2014

(54) FACILITATING INTERNAL MOBILITY WITHIN AN ORGANIZATION

(71) Applicant: Linkedln Corporation, Mountain View, CA (US)

(72) Inventors: Manisha Gupta, San Ramon, CA (US); Lindsay Browning, Charlestown (IE); Marcus Edeback, London (GB); Rory Cawley, Dublin (IE); Ross Carvalho, Berkshire (GB); Liam Walsh, San Francisco, CA (US)

(73) Assignee: Linkedln Corporation, Mountain View, CA (US)

(21) Appl. No.: 14/029,614

(22) Filed: Sep. 17, 2013

Related U.S. Application Data
(60) Provisional application No. 61/828,988, filed on May 30, 2013.

(51) Int. Cl. G06Q 10/10

(52) U.S. Cl. CPC G06Q 10/105
USPC 705/320

(57) ABSTRACT

Systems and methods for facilitating internal mobility within an organization are described. In some example embodiments, the systems and methods may cause a display of a graphical user interface associated with a first entity of an organization, such as a single employee, a team of employees, and/or a job listing service of the organization, where the graphical user interface includes information associated with the first entity of the organization, and cause a display of a display element within the graphical user interface that is associated with a second, different, entity of the organization and that includes information associated with the second entity of the organization.

### CROSS REFERENCE TO RELATED APPLICATIONS

This application claims priority to U.S. Provisional Patent Application No. 61/828,988, filed on May 30, 2013, entitled FACILITATING INTERNAL MOBILITY WITHIN AN ORGANIZATION, which is hereby incorporated by reference in its entirety.

### TECHNICAL FIELD

The present disclosure generally relates to the fields of information processing and information display. More specifically, the present disclosure relates to methods, systems and computer program products for facilitating internal mobility within an organization.

### BACKGROUND

Internal mobility within a large organization, such as a company having multiple teams or divisions of employees, is a valuable process by which the large organization may move employees within the organization to different teams and into different roles, in order to satisfy the current or changing staffing and talent needs of the organization. However, many organizations do not effectively utilize internal mobility, as they lack the knowledge or resources needed to identify and match people within the organization to teams in which they would be well utilized. This lack of knowledge and resources may cause high attrition rates, as employees find opportunities outside of the organization, and may waste organization resources, as it is generally more expensive to recruit and hire people from outside an organization than from within the organization.

### DESCRIPTION OF THE DRAWINGS

Some embodiments of the technology are illustrated by way of example and not limitation in the figures of the accompanying drawings.

FIG. 1 is a block diagram illustrating various functional components of a suitable computing environment, consistent with some embodiments, for facilitating internal mobility within an organization.

FIG. 2 is a block diagram illustrating example modules of an internal mobility system, consistent with some embodiments.

FIG. 3 is a display diagram illustrating an example user interface provided by an internal mobility system that is associated with a team within an organization, consistent with some example embodiments.

FIG. 4 is a display diagram illustrating an example user interface provided by an internal mobility system that is associated with a job page within an organization, consistent with some example embodiments.

FIG. 5 is a display diagram illustrating an example user interface provided by an internal mobility system that is associated with an employee within an organization, consistent with some example embodiments.

FIG. 6 is a flow diagram illustrating an example method for displaying a user interface associated with facilitating internal mobility within an organization, consistent with some embodiments.

FIG. 7 is a flow diagram illustrating an example method for providing recommendations based on portal interactions, consistent with some embodiments.

FIG. 8 is a block diagram of a machine in the form of a computing device within which a set of instructions, for causing the machine to perform any one or more of the methodologies discussed herein, may be executed.

### DETAILED DESCRIPTION

### Overview

The present disclosure describes methods, systems, and computer program products, which individually provide functionality for facilitating internal mobility within an organization. For example, the systems and methods described herein may provide various online or web-based portals that promote and connect teams of employees to other employees within the organization, among other things.

In some example embodiments, the systems and methods may cause a display of a graphical user interface associated with a first entity of an organization, such as a single employee, a team of employees, and/or a job listing service of the organization, where the graphical user interface includes information associated with the first entity of the organization, and cause a display of a display element within the graphical user interface that is associated with a second, different, entity of the organization and that includes information associated with the second entity of the organization.

For example, the graphical user interface may present a job listing page (the first entity) representing a job listing for an available job with a team of the organization along with content provided by the team (the second entity), such as information identifying employees within the team, information associated with projects being worked on, videos and other branding for the team, and so on.

In some example embodiments, the systems and methods may track information associated with the portal in order to streamline hiring processes within the organization. For example, the systems and methods may receive and/or access information identifying a recruiting goal for a team within an organization, determine a metric based on interactions between employees of the organization and a portal associated with the team; the metric associated with satisfying the recruiting goal with internal candidates of the organization, compare the recruiting goal to the determined metric, and provide a recommendation (e.g., a number or type of external candidates to recruit) associated with recruiting individuals outside of the organization to the team within the organization based on the comparison.

Therefore, in some example embodiments, the systems and methods may facilitate the efficient and timely movement of employees within an organization to different roles and/or teams within the organization, enabling the employees to work in different aspects of an organization while enabling the organization to effectively utilize internal mobility to better align the talent within the organization to the needs of the organization, among other benefits.

In the following description, for purposes of explanation, numerous specific details are set forth in order to provide a thorough understanding of the various aspects of different embodiments of the present invention. It will be evident, however, to one skilled in the art, that the present invention may be practiced without all of the specific details.

Other advantages and aspects of the inventive subject matter will be readily apparent from the description of the figures that follows.

### Suitable Computing Environment

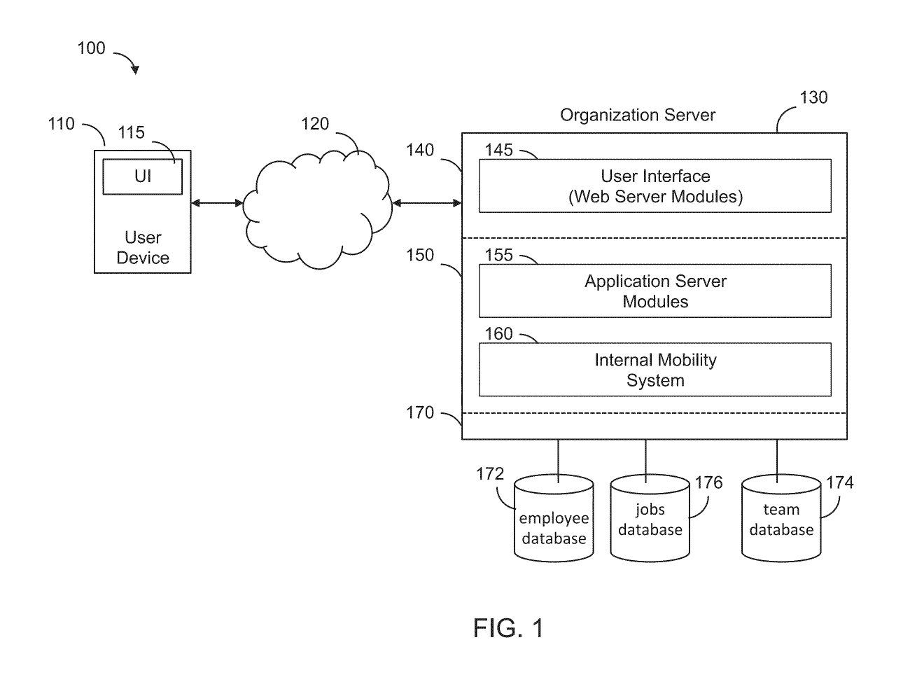

FIG. 1 is a block diagram illustrating various functional components of a suitable computing environment 100, consistent with some embodiments, for facilitating internal mobility within an organization.

As shown in FIG. 1, the computing environment 100 includes an organization server 130, such as a server that supports an Intranet or other internal networked environment, which is generally based on a three-tiered architecture, consisting of a front-end layer 140, an application logic layer 150, and a data layer 170. The modules, systems, and/or engines shown in FIG. 1 represent a set of executable software instructions and the corresponding hardware (e.g., memory and processor) for executing the instructions. However, one skilled in the art will readily recognize that various additional functional modules and engines may be used with the server 130 to facilitate additional functionality that is not specifically described herein. Furthermore, the various functional modules and engines depicted in FIG. 1 may reside on a single server computer, or may be distributed across several server computers in various arrangements.

As shown in FIG. 1, the front-end layer 140 includes a user interface module (e.g., a web server) 145, which receives requests from various client-computing devices, such as a user device 110, over a network 120, and communicates appropriate responses to the requesting client devices. For example, the user interface module(s) 140 may receive requests in the form of Hypertext Transport Protocol (HTTP) requests, or other web-based, application programming interface (API) requests. The client devices 110 may be executing conventional web browser applications, or applications that have been developed for a specific platform to include any of a wide variety of mobile devices and operating systems.

The network 120 may be any communications network utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, wireless data networks (e.g., Wi-Fi® and WiMax® networks), and so on.

As shown in FIG. 1, the data layer 170 includes several databases, including databases for storing data associated with the organization, such as an employee database 172 that stores data and other information associated with employees of the organization, a team database 174 that stores data and other information associated with teams of employees within the organization (e.g., product teams, service teams, organizational teams, project-specific teams, and so on), and/or a jobs database 176 that stores data and other information associated with job listings and job application activities for available jobs within the organization (e.g., for available jobs with certain teams within the organization).

The application logic layer 150 includes various application server modules 155, which, in conjunction with the user interface module(s) 145, generates various user interfaces (e.g., web pages) with data retrieved from various data sources in the data layer 170. In some example some embodiments, individual application server modules 155 are used to implement the functionality associated with various applications, services and features of the server 130. For example, a messaging application, such as an email application, an instant messaging application, or some hybrid or variation of the two, may be implemented with one or more application server modules 155. Similarly, a search engine enabling users to search for and browse employees pages, team pages, job listing pages, and so on, may be implemented with one or more application server modules 155.

In addition to the various application server modules 155, the application logic layer 150 also includes an internal mobility system 160, or portal, that facilitates the presentation of user interfaces associated with entities (e.g., employees, teams, job listing services, and so on) of the organization. Of course, other applications or services that utilize the internal mobility system 160 may be separately embodied in their own application server modules 155.

The internal mobility system 160 may perform one or more algorithmic processes that facilitate connections between employees of an organization and teams or available roles with the organization, such as algorithmic processes that cause the display and/or presentation of user interfaces that contain information provided by multiple entities, among other things.

As illustrated in FIG. 1, in some example embodiments, the internal mobility system 160 is implemented as a service that operates in conjunction with various application server modules 155. For instance, any number of individual application server modules 155 may invoke the functionality of the internal mobility system 160, to include an application server module associated with receiving information from the user device 110 and/or an application server module associated with an application to facilitate the viewing of user interfaces, such as via the user interface 115 of user device 110. However, in some example embodiments, the internal mobility system 160 may be implemented as its own application server module such that it operates as a stand-alone application or system.

In some example embodiments, the internal mobility system 160 may include or have an associated publicly available Application Programming Interface (API) that enables third-party applications or other applications, algorithms or scripts within the organization to invoke the functionality of the internal mobility system 160, among other things.

Thus, in some example embodiments, the internal mobility system 160 or portal facilitates connections between employees and teams or roles provided by an organization by providing user interfaces that act to advertise the needs of entities within the organization and/or exchange information between the entities of the organization, among other things.

### Examples for Displaying Information Via an Internal Mobility Portal

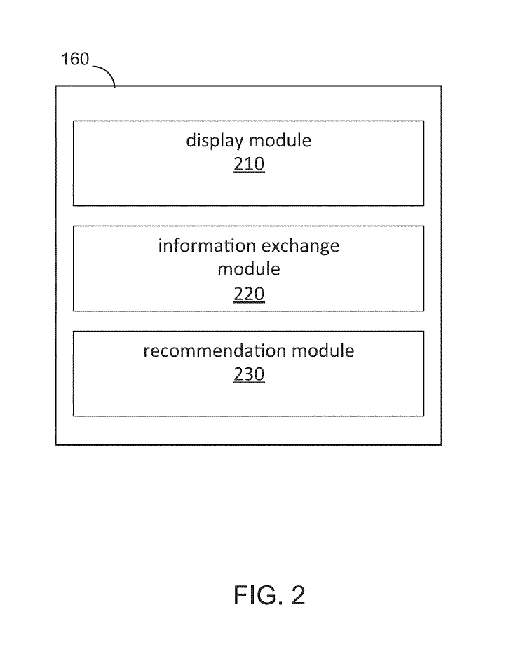

As described herein, in some example embodiments, the internal mobility system 160 supports and/or provides a portal that connect entities within an organization, such as a portal that presents user interfaces displaying information associated with employees, teams of employees, job services, and other entities of an organization. FIG. 2 is a block diagram illustrating example modules of the internal mobility system 160, consistent with some embodiments.

As illustrated in FIG. 2, the internal mobility system 160 includes a variety of functional modules. One skilled in the art will appreciate that the functional modules are implemented with a combination of software (e.g., executable instructions, or computer code) and hardware (e.g., at least a memory and processor). Accordingly, as used herein, in some example embodiments a module is a processor-implemented module and represents a computing device having a processor that is at least temporarily configured and/or programmed by executable instructions stored in memory to perform one or more of the particular functions that are described herein. Referring to FIG. 2, the internal mobility system 160 includes a display module 210, an information exchange module 220, and a recommendation module 230.

In some example embodiments, the display module 210 is configured and/or programmed to cause a display of a graphical user interface associated with a first entity of an organization that includes information associated with the first entity of the organization. An entity may be a single employee, a team of employees, a job listing service, or any other individual, group of individuals, department, and/or service of an organization (e.g., a company) that is associated with an organization and/or provides a page or portal to be viewed by employees of the organization.

In some example embodiments, the information exchange module 220 is configured and/or programmed to cause a display of a display element within the graphical user interface that is associated with a second, different, entity of the organization, and that includes information associated with the second entity of the organization. For example, the display element may provide information (e.g., content from a marketing team) within a user interface (e.g., a job listing) associated with an entity (e.g., a job services group), the information provided by and/or associated with another entity (e.g., the marketing team).

As described herein, the display module 210 and the information exchange module 220 may enable the presentation of user interfaces having various configurations of presented information. Example configurations include:

A configuration where the graphical user interface associated with a first entity of an organization presents a page associated with the employee, and wherein the display element associated with the second entity of the organization presents content provided by the team of employees;

A configuration where the graphical user interface associated with a first entity of an organization presents a page associated with the employee, and wherein the display element associated with the second entity of the organization presents one or more job listings provided by the job listing service, the job listings representing available jobs within the organization;

A configuration where the graphical user interface associated with a first entity of an organization presents a page associated with the team of employees, and wherein the display element associated with the second entity of the organization presents information associated with an employee within the organization within a different team of employees of the organization;

A configuration where the graphical user interface associated with a first entity of an organization presents a page associated with the team of employees, and wherein the display element associated with the second entity of the organization presents one or more job listings provided by the job listing service, the job listings representing available jobs within the team of employees;

A configuration where the graphical user interface associated with a first entity of an organization presents a page associated with the team of employees, and wherein the display element associated with the second entity of the organization presents one or more job listings provided by the job listing service, the job listings representing available jobs within the team of employees determined to be suitable for an employee of the organization that is currently viewing the page associated with the team of employees;

A configuration where the graphical user interface associated with a first entity of an organization presents a job listing page for the job listing service that includes one or more job listings provided by the job listing service, the job listings representing available jobs within a certain team of employees, and wherein the display element associated with the second entity of the organization presents content associated with the certain team of employees; and/or

A configuration where the graphical user interface associated with a first entity of an organization presents a job listing page for the job listing service that includes one or more job listings provided by the job listing service, the job listings representing available jobs within a certain team of employees, and wherein the display element associated with the second entity of the organization presents content associated with the certain team of employees and associated with an employee of the organization that is currently viewing the job listing page for the job listing service; and so on.

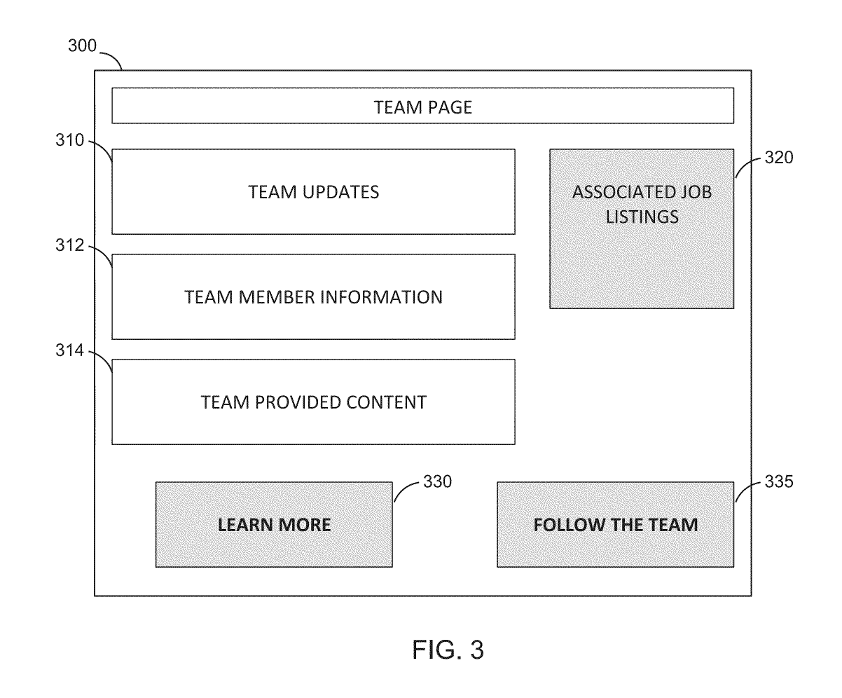

Thus, in some example embodiments, the portal may include and/or support a user interface provided by a certain entity that includes information from the entity, as well as information provided by another entity. FIG. 3 is a display diagram illustrating an example user interface 300 provided by the internal mobility system 160 that is associated with a team within an organization, consistent with some example embodiments.

The user interface 300 displays a team page within the portal, such as a page associated with a team of employees within an organization. The user interface 300 may include and/or display information associated with the team, such as team update information 310 (e.g., content describing updates, members, or projects of the team), team member information 312 (e.g., information associated with members of the team), team provided content 314 (e.g., videos, pictures, images, documents, and/or other content that may provide insight or be related to the team and/or its members), and other displayed information not shown in the Figure.

As described herein, the user interface 300 also includes display elements that include, display, and/or present information from one or more entities within the organization, such as display element 320 that displays job listings for available jobs with the team represented by the team page. Further, the user interface may include various user-selectable elements that facilitate interactions between viewers and the user interface, such as a user-selectable element 330 that, when selected, presents the viewer with more information about the team, and/or user-selectable element 335 that, when selected, enables the viewer to follow the team and associated activities (e.g., blog posts, job postings, updates, and so on) performed by the team within the portal. Of course, the user interface 300 may include other information and/or displayed content.

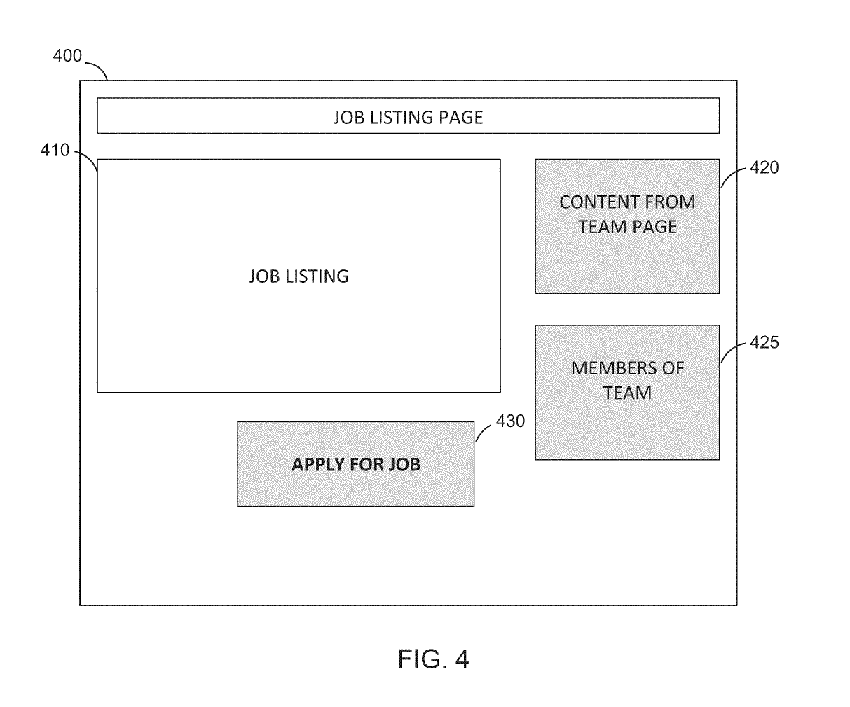

FIG. 4 is a display diagram illustrating an example user interface 400 provided by the internal mobility system 160 that is associated with a job page within an organization, consistent with some example embodiments.

The user interface 400 displays a job listing page within the portal, such as a page associated with an available job within an organization and provided by a job listing service (e.g., a career site, an applicant tracking service, and so on) of the organization. The user interface 400 may include and/or display information describing an available job, such as a job listing 410 (e.g., information describing the job, the required skills, the required education, the required experience, and so on), as well as a user-selectable element 430 that, when selected, enables a viewer of the page to apply for the page, obtain more information about the job, and so on.

As described herein, the user interface 400 also includes display elements that include, display, and/or present information from one or more entities within the organization, such as a display element 420 that displays content from a team page representing a team with which the job is located, and/or display element 425 that displays content for members of the team with which the job is located. Of course, the user interface 400 may include other information and/or displayed content.

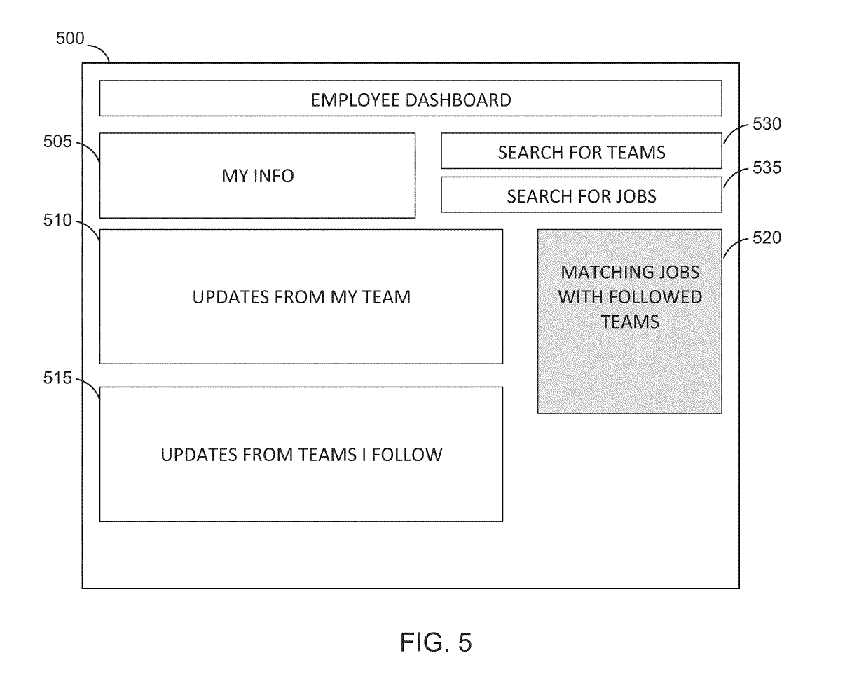

FIG. 5 is a display diagram illustrating an example user interface 500 provided by the internal mobility system 160 that is associated with an employee within an organization, consistent with some example embodiments. The user interface 500 displays an employee dashboard within the portal, such as a page associated with a single employee or individual associate with the organization. The user interface 500 may include and/or display employee specific information 505, team update information 510 for a team that includes the employee as a member, other team update information 515 for teams followed by the employee, and so on.

As described herein, the user interface 500 also includes display elements that include, display, and/or present information from one or more entities within the organization, such as a display element 520 that displays job listings for available jobs with teams followed by the employee (e.g., job listings that match the skills and/or attributes of the employee). Further, the user interface 500 may provide various elements that enable the employee to navigate and/or otherwise interact with the portal, such as a search box 530 that facilitates searches for teams, a search box 535 that facilitates searches for available jobs, and so on. Of course, the user interface 500 may include other information and/or displayed content.

In some example embodiments, the internal mobility system 160 may include other user interfaces, such as interfaces associated with administrators and human resources personnel that provide navigation tools, metrics, analytics, reports, and so on.

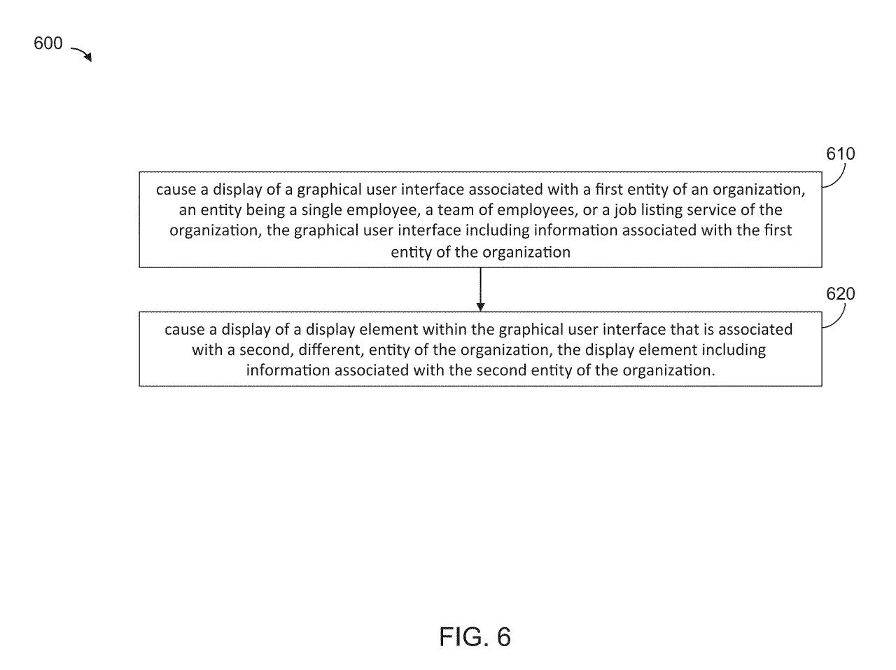

Therefore, in some example embodiments, the internal mobility system 160 may perform various methods in order to connect employees to teams and/or roles within an organization, among other things. FIG. 6 is a flow diagram illustrating an example method 600 for displaying a user interface associated with facilitating internal mobility within an organization, consistent with some embodiments. The method 600 may be performed by the internal mobility system 160 and, accordingly, is described herein merely by way of reference thereto. It will be appreciated that the method 600 may be performed on any suitable hardware.

In operation 610, the internal mobility system 160 causes a display of a graphical user interface associated with a first entity of an organization, an entity being a single employee, a team of employees, or a job listing service of the organization, the graphical user interface including information associated with the first entity of the organization. For example, the display module 210 may cause a display of a graphical user interface associated with a first entity of an organization that includes information associated with the first entity of the organization. An entity may be a single employee, a team of employees, a job listing service, or any other individual, group of individuals, department, and/or service of an organization (e.g., a company) that is associated with an organization and/or provides a page or portal to be viewed by employees of the organization.

In operation 620, the internal mobility system 160 causes a display of a display element within the graphical user interface that is associated with a second, different, entity of the organization, the display element including information associated with the second entity of the organization. For example, the information exchange module 220 may render, or cause to be rendered, a display element provides information from other entities supported by the portal that are not associated with the currently displayed user interface.

For example, the internal mobility system 160 may generate and/or display a user interface presenting a job listing for an available job, identify a team associated with the available job, retrieve and/or access information or content provided by and/or associated with the team, and present the information associated with the team along with the job listing.

In some example embodiments, the internal mobility system 160 may track and/or monitor interactions between employees and other views of user interfaces (e.g., pages, display elements, user-selectable elements, input boxes, and so on), and provide recommendations associated with hiring or other employee acquisition or retention goals, among other things.

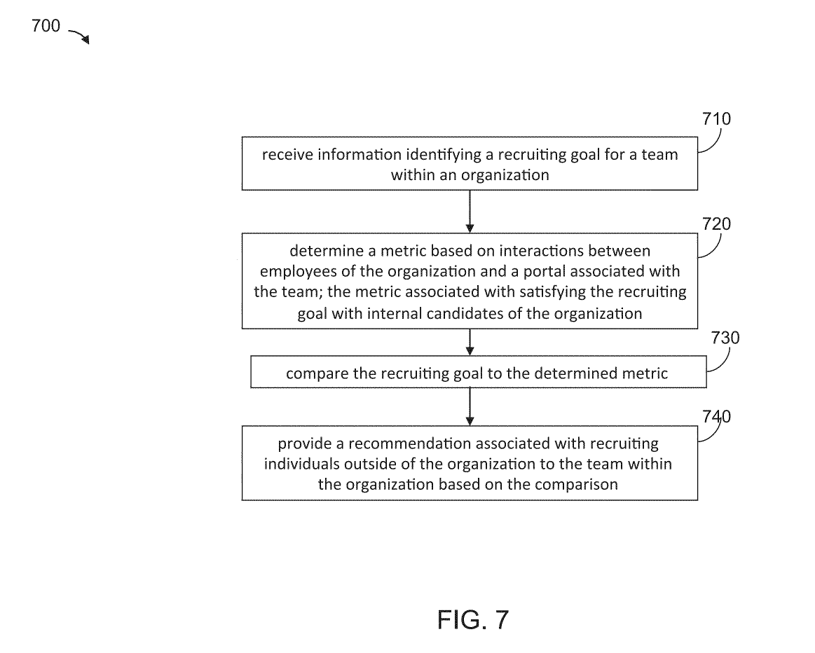

FIG. 7 is a flow diagram illustrating an example method 700 for providing recommendations based on portal interactions, consistent with some embodiments. The method 700 may be performed by the internal mobility system 160 and, accordingly, is described herein merely by way of reference thereto. It will be appreciated that the method 700 may be performed on any suitable hardware.

In operation 710, the internal mobility system 160 receives and/or accesses information identifying a recruiting goal for a team within an organization. For example, the system 160 may receive a recruiting goal of a number of new employees to hire, a number of employees to transition to a new team or role, a certain type of new employees to hire, a number of internal viewers of the portal, a number of external viewers of job listings, and combinations thereof.

In operation 720, the internal mobility system 160 determines a metric based on interactions between employees of the organization and a portal associated with the team, the metric associated with satisfying the recruiting goal with internal candidates of the organization. For example, the system 160 may determine a metric associated with a number of viewers of the portal (e.g., 900 viewers in the past week), a number of certain types of viewers of the portals, the actions performed by the viewers within the portal, and so on.

In some example embodiments, the system may determine the metric based on a number of employees that interacted with the portal associated with the team, and/or based on a number of suitable candidates that interacted with the portal associated with the team, the suitable candidates being employees of the organization having characteristics that match one or more characteristics associated with one or more available jobs with the team.

In operation 730, the internal mobility system 160 compares the recruiting goal to the determined metric. For example, the system 160 may determine a difference and/or percentage difference between viewership and applicants, between internal employee viewers and available positions, and so on.

In operation 740, the internal mobility system 160 provides a recommendation associated with recruiting individuals outside of the organization to the team within the organization based on the comparison. For example, the system 160 may provide a recommendation to reduce the hiring goal, to increase the hiring goal, to reduce the number of external or internal job advertisements, to modify the external or internal job advertisements, and so on.

Thus, in some example embodiments, the internal mobility system 160 may facilitate the generation of analytics and recommendations associated with hiring and/or retention goals, enabling recruiters in an organization to identify potential internal candidates (or, internal mobility trends) and adjust their external recruiting efforts accordingly, among other benefits.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules, engines, objects or devices that operate to perform one or more operations or functions. The modules, engines, objects and devices referred to herein may, in some example embodiments, comprise processor-implemented modules, engines, objects and/or devices.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

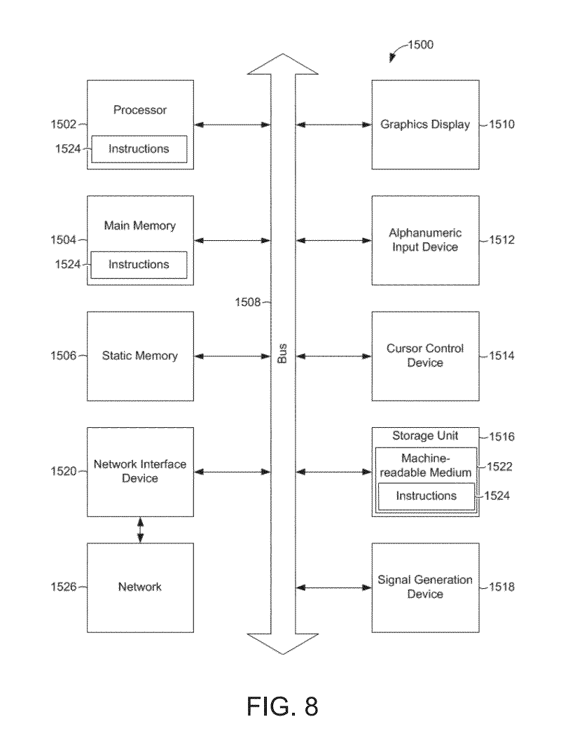

FIG. 8 is a block diagram of a machine in the form of a computer system or computing device within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment. In some embodiments, the machine will be a desktop computer, or server computer, however, in alternative embodiments, the machine may be a tablet computer, a mobile phone, a personal digital assistant, a personal audio or video player, a global positioning device, a set-top box, a web appliance, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1504 and a static memory 1506, which communicate with each other via a bus 1508. The computer system 1500 may further include a display unit 1510, an alphanumeric input device 1512 (e.g., a keyboard), and a user interface (UI) navigation device 1514 (e.g., a mouse). In one embodiment, the display, input device and cursor control device are a touch screen display. The computer system 1500 may additionally include a storage device 1516 (e.g., drive unit), a signal generation device 1518 (e.g., a speaker), a network interface device 1520, and one or more sensors, such as a global positioning system sensor, compass, accelerometer, or other sensor.

The drive unit 1516 includes a machine-readable medium 1522 on which is stored one or more sets of instructions and data structures (e.g., software 1524) embodying or utilized by any one or more of the methodologies or functions described herein. The software 1524 may also reside, completely or at least partially, within the main memory 1504 and/or within the processor 1502 during execution thereof by the computer system 1500, the main memory 1504 and the processor 1502 also constituting machine-readable media.

While the machine-readable medium 1522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1524 may further be transmitted or received over a communications network 1526 using a transmission medium via the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although some embodiments has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

1. A method, comprising:
causing, by one or more hardware processors, a display of a graphical user interface associated with a first entity of an organization, an entity being a single employee, a team of employees, or a job listing service of the organization, the graphical user interface including information associated with the first entity of the organization; and
causing, by the one or more hardware processors, a display of a display element within the graphical user interface based on identifying a relationship between the first entity of the organization and the second, different, entity of the organization, the display element being associated with a second, different, entity of the organization, the display element including information associated with the second entity of the organization.

2. The method of claim 1, wherein the graphical user interface associated with a first entity of an organization presents a page associated with the employee, and wherein the display element associated with the second entity of the organization presents content provided by the team of employees.

3. The method of claim 1, wherein the graphical user interface associated with a first entity of an organization presents a page associated with the employee, and wherein the display element associated with the second entity of the organization presents one or more job listings provided by the job listing service, the job listings representing available jobs within the organization.

4. The method of claim 1, wherein the graphical user interface associated with a first entity of an organization presents a page associated with the team of employees, and wherein the display element associated with the second entity of the organization presents information associated with an employee within the organization within a different team of employees of the organization.

5. The method of claim 1, wherein the graphical user interface associated with a first entity of an organization presents a page associated with the team of employees, and wherein the display element associated with the second entity of the organization presents one or more job listings provided by the job listing service, the job listings representing available jobs within the team of employees.

6. The method of claim 1, wherein the graphical user interface associated with a first entity of an organization presents a page associated with the team of employees, and wherein the display element associated with the second entity of the organization presents one or more job listings provided by the job listing service, the job listings representing available jobs within the team of employees determined to be suitable for an employee of the organization that is currently viewing the page associated with the team of employees.

7. The method of claim 1, wherein the graphical user interface associated with a first entity of an organization presents a job listing page for the job listing service that includes one or more job listings provided by the job listing service, the job listings representing available jobs within a certain team of employees, and wherein the display element associated with the second entity of the organization presents content associated with the certain team of employees.

8. The method of claim 1, wherein the graphical user interface associated with a first entity of an organization presents a job listing page for the job listing service that includes one or more job listings provided by the job listing service, the job listings representing available jobs within a certain team of employees, and wherein the display element associated with the second entity of the organization presents content associated with the certain team of employees and associated with an employee of the organization that is currently viewing the job listing page for the job listing service.

9. A system, comprising:
one or more hardware processors;
a display module that is implemented by the one or more hardware processors and configured to cause a display of a graphical user interface associated with a first entity of an organization, an entity being a single employee, a team of employees, or a job listing service of the organization, the graphical user interface including information associated with the first entity of the organization; and
an information exchange module that is implemented by the one or more hardware processors and configured to cause a display of a display element within the graphical user interface based on identifying a relationship between the first entity of the organization and the second, different, entity of the organization, the display element being associated with a second, different, entity of the organization, the display element including information associated with the second entity of the organization.

10. The system of claim 1, wherein the graphical user interface associated with a first entity of an organization presents a page associated with the employee, and wherein the display element associated with the second entity of the organization presents content provided by the team of employees.

11. The system of claim 1, wherein the graphical user interface associated with a first entity of an organization presents a page associated with the employee, and wherein the display element associated with the second entity of the organization presents one or more job listings provided by the job listing service, the job listings representing available jobs within the organization.

12. The system of claim 1, wherein the graphical user interface associated with a first entity of an organization presents a page associated with the team of employees, and wherein the display element associated with the second entity of the organization presents information associated with an employee within the organization within a different team of employees of the organization.

13. The system of claim 1, wherein the graphical user interface associated with a first entity of an organization presents a page associated with the team of employees, and wherein the display element associated with the second entity of the organization presents one or more job listings provided by the job listing service, the job listings representing available jobs within the team of employees.

14. The system of claim 1, wherein the graphical user interface associated with a first entity of an organization presents a page associated with the team of employees, and wherein the display element associated with the second entity of the organization presents one or more job listings provided by the job listing service, the job listings representing available jobs within the team of employees determined to be suitable for an employee of the organization that is currently viewing the page associated with the team of employees.

15. The system of claim 1, wherein the graphical user interface associated with a first entity of an organization presents a job listing page for the job listing service that includes one or more job listings provided by the job listing service, the job listings representing available jobs within a certain team of employees, and wherein the display element associated with the second entity of the organization presents content associated with the certain team of employees.

16. The system of claim 1, wherein the graphical user interface associated with a first entity of an organization presents a job listing page for the job listing service that includes one or more job listings provided by the job listing service, the job listings representing available jobs within a certain team of employees, and wherein the display element associated with the second entity of the organization presents content associated with the certain team of employees and associated with an employee of the organization that is currently viewing the job listing page for the job listing service.

17. A computer-readable storage medium whose contents, when executed by a computing system, cause the computing system to perform operations, comprising:
receiving information identifying a recruiting goal for a team within an organization;
determining a metric based on interactions between employees of the organization and a portal associated with the team; the metric associated with satisfying the recruiting goal with internal candidates of the organization;
comparing the recruiting goal to the determined metric; and
providing a recommendation associated with recruiting individuals outside of the organization to the team within the organization based on the comparison.

18. The computer-readable storage medium of claim 17, wherein interactions between employees of the organization and a portal associated with the team include a number of views of job listings provided by the portal and associated with available jobs with the team.

19. The computer-readable storage medium of claim 17, wherein interactions between employees of the organization and a portal associated with the team include a number of views of content provided by the portal and associated with available jobs with the team.

20. The computer-readable storage medium of claim 17, wherein determining a metric based on interactions between employees of the organization and a portal associated with the team includes determining a metric that is based on a number of employees that interacted with the portal associated with the team.

21. The computer-readable storage medium of claim 17, wherein determining a metric based on interactions between employees of the organization and a portal associated with the team includes determining a metric that is based on a number of suitable candidates that interacted with the portal associated with the team, the suitable candidates being employees of the organization having characteristics that match one or more characteristics associated with one or more available jobs with the team.
